(19) United States
(12) Patent Application Publication
(10) Pub. No.: US 2011/0093263 A1
(43) Pub. Date: Apr. 21, 2011

(54) Automated Video Captioning

(76) Inventor: Shahin M. Mowzoon, Chandler, AZ (US)

(21) Appl. No.: 12/907,985

(22) Filed: Oct. 19, 2010

Related U.S. Application Data
(60) Provisional application No. 61/279,443, filed on Oct. 20, 2009.

(51) Int. Cl. G10L 15/26

(52) U.S. Cl. 704/235; 704/E15.043

(57) ABSTRACT

An automated closed captioning, captioning, or subtitle generation system that automatically generates the captioning text from the audio signal in a submitted online video and then allows the user to type in any corrections after which it adds the captioning text to the video allowing users to enable the captioning as needed. The user text review and correction step allows the text prediction model to accumulate additional corrected data with each use thereby improving the accuracy of the text generation over time and use of the system.

### CROSS-REFERENCE TO RELATED APPLICATIONS

This application claims priority under 35 USC 119 from U.S. Provisional Application Ser. No. 61/279,443 files on Oct. 20, 2009, titled AUTOMATED VIDEO CAPTIONING by inventor Shahin M. Mowzoon, which is incorporated herein.

### FIELD OF THE INVENTION

This invention relates in general to a computer system for generating text and, more specifically, to automated captioning of video content.

### BACKGROUND

Most video content available through the internet lack captioned text. Therefore what is needed is a system and method that can capture a file with audio and video content and produced text in the form commonly known as closed captioned text, which is defined as captioning that may be available to some portion of the audience.

It would be useful to automatically be able to generate text from a submitted video and add the text to the submitted video as captioning without requiring manual tasks involving someone to transcribe or in some manual way facilitate the generating of such text. Namely, it would be useful for anyone who is submitting a video to a web site such as Youtube.com © to have the option of having captioning added to their video automatically without incurring significant cost or time required for captioning such video that individual submitters will generally forgo. Such a capability will, for example, allow the hearing impaired to make use of these videos, will make possible the translation of such videos to different languages and enable search engines to search through the said videos using standard internet text searches.

There are various methods of captioning. Current commercially available speech recognition software requires training of the said software using the user's voice and will then work properly only with that single trained voice. Accuracy near the mid ninety percent is commonplace with dictation. More recently however, general solutions that do not require individual custom speech training have become more capable. The Google 411© free directory service (1-800-GOOG-411) is a good example of this. Such services rely on an expanding training data set to help improve their accuracy. Another common approach is creating a computer text file that contains the timing and text to be included in the video. Many of the video playing software systems are then capable of handling such files. One example is the “.SMI” type files often used with Windows Media Player. Such files often may contain font and formatting information as well as the timing of the captions. The current methods of captioning require someone to listen to the video, note down what is being said and record this along with the timing. Then the information can be one way or another be embedded into the video. Some sites allow manual captioning of online videos (for example Dotsub.com and Youtube.com). Software also exists to help facilitate adding captions once the text and timing is known (example: URUWorks Subtitle Workshop). The MPEG-4 standard allows including the captions directly into the video file format. But all such solutions require much manual labor requiring a human operator to manually listen to the video and create the text and timing prior to any follow-up step.

Current methods of adding closed captions rely on manual steps involving either transcription by a human operator or alternatively captioning by having someone doing a voice-over on the video, someone who's voice has been used to custom train one of the existing speech recognition software systems. Both these methods require manual steps involving human intervention and do not lend themselves to ubiquitous closed captioning of video content on the web.

Therefore was is needed is a system and method for creating a mechanism that does not rely on expensive manual steps and provides a simple to use solution for generating text or closed caption text from a file that contains at least and audio portion.

### SUMMARY

In accordance with the teaching of the present invention, a file that includes video to be captioned is submitted to a web site on the Internet and subtitles or closed captioning is added automatically using machine learning techniques. The originator or user can then view the automatically generated closed captioned text, make corrections and submit the corrected text to be added as captioning to the said video content.

### BRIEF DESCRIPTION OF THE FIGURES

For a detailed description of the exemplary implementations, reference is made to the accompanying drawings in which:

FIG. 1 depicts a general flow chart describing various supervised learning algorithms;

FIG. 2 depicts the user experience and one possible embodiment of a user interface;

FIG. 3 depicts the main flow as initiated by the user submission process;

FIG. 4 depicts the relation of the correction submissions to future training set data; and

FIG. 5 depicts one possible representation of signal layers involved.

### DETAILED DESCRIPTION

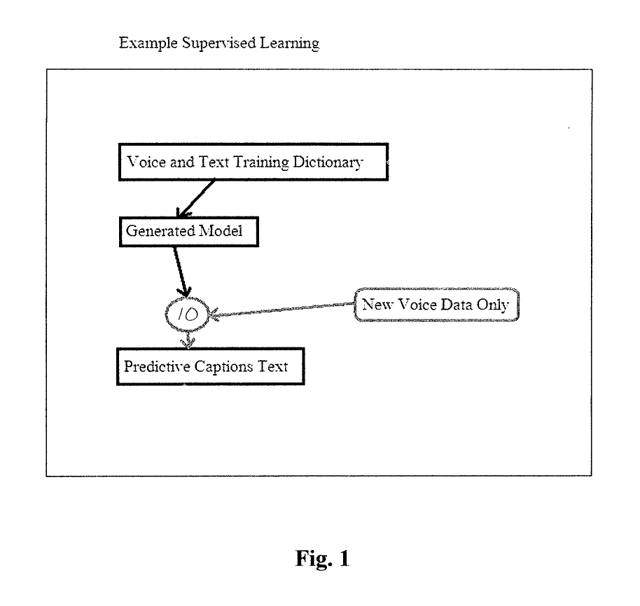

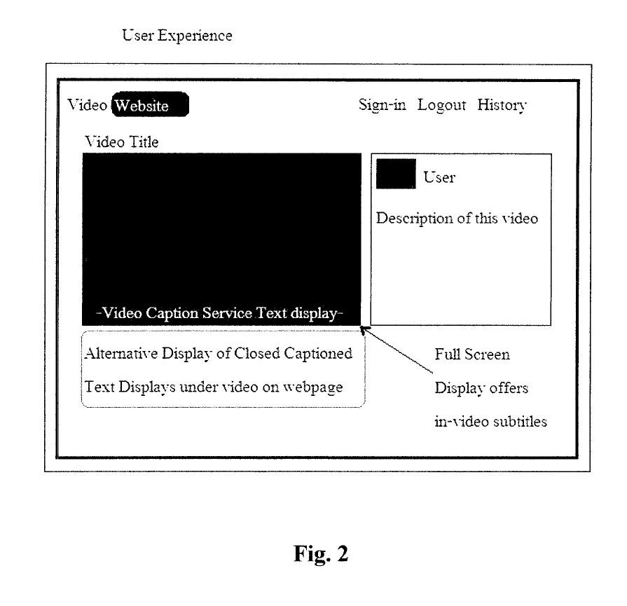

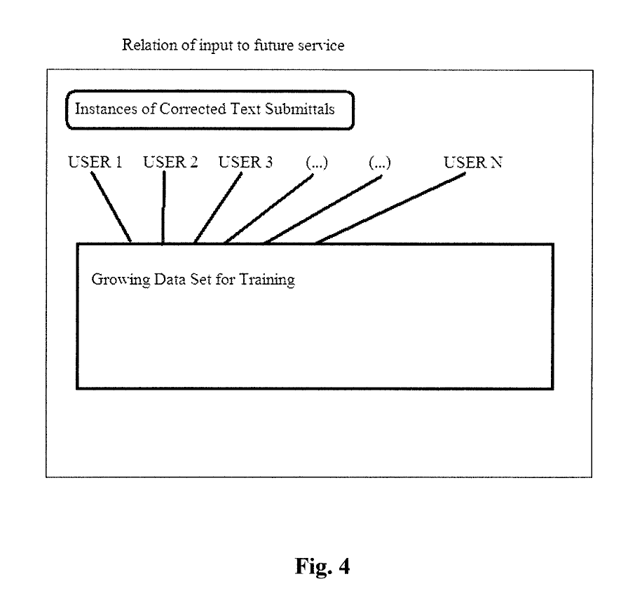

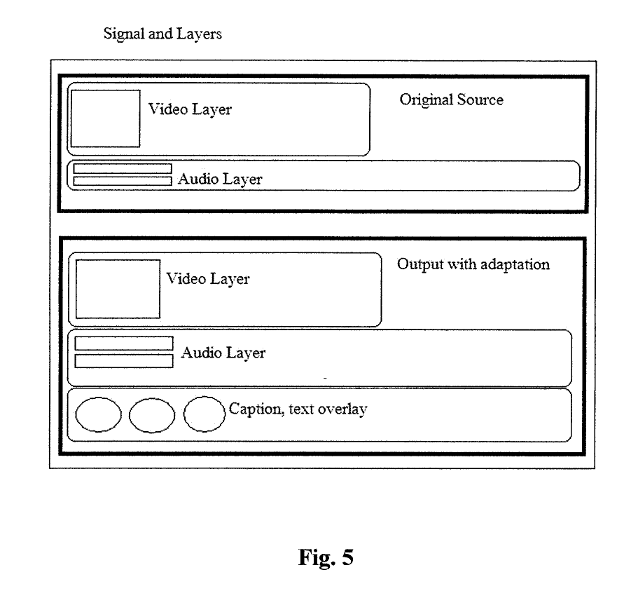

Referring generally to FIGS. 1-5, the following description is provided with respect to the various components of the system. Referring now to FIG. 1, a file 10 is shown with various systems interacting and operating upon the file 10.

Data objects: Data stored on a computer is often represented in form of multidimensional objects or vectors. Each of the dimensions of such a vector can represent some variable. Some examples are: count of a particular word, intensity of a color, x and y position, signal frequency or magnitude of a voice waveform at a given time or frequency band.

Machine Learning Techniques: The fields of Signal Processing, Multivariate Statistics, Data Mining, and Machine Learning have been converging for sometime. Henceforth we shall refer to this area as “Machine Learning”. In Machine Learning, supervised learning involves using models or techniques that get “trained” on a data set and later are used on new data in order to categorize that new data, predict results or create a modeled output based on the training as well as the new data. Supervised techniques often may need an output or response variable or a classification label to be present along with input training data as depicted in FIG. 1. In unsupervised learning methods no response variable or label is needed, it is more of a technique where all variables are inputs and the data is usually grouped by distance or dissimilarity functions using various algorithms and methods. A relevant example of the supervised learning model may be a model based on a training data set that contains words in form of text that are associated with voice recordings of those words forming a training vocabulary that can then be used to predict text from a new set of voice signals an embodiment of which is shown in FIG. 1.

Supervised Learning Methods: There are a great number of Supervised Learning techniques. These include but are not limited to hidden markov models, decision trees, regression techniques, multiple regression, support vector machines and artificial neural networks. These are very powerful techniques that need a training step using a training set of data before they can be applied to predict on an unknown set of data.

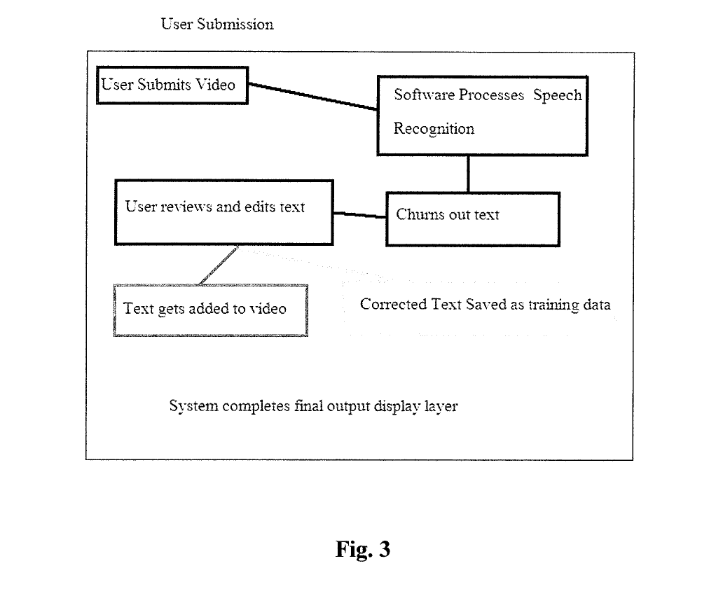

Implementation involves (1) using supervised learning techniques to train a model, (2) use the model to predict the text, (3) provide the text to user for corrections, (4) add the corrected text as captioning, (5) add the corrected text and voice into the training model data set to improve model accuracy as described in FIG. 3.

The voice information can be thought of as digitized waveform against a time axis typically with some sampling rate so the wave has some value for each sampling delta time. As such, the timing information is a trivial part of the data. The main challenge is converting the waveform of a speech to digitized text. As mentioned various supervised machine learning algorithms can accomplish this. Hidden markov models and neural networks are just some examples of such models. Any machine learning algorithms that rely on a training data set fall under the general category of supervised techniques. Software for speech recognition has improved mainly from such supervised algorithms employing larger and diverse data sets that may represent the population of users. This training data we can call the data dictionary if you like is used to train the model. Then given an unknown input it can predict the word or text based on its training. This information combined with the accompanied timestamp can then be fed into any number of the captioning solutions.

Although the system is not 100% accurate the user can edit and upload the corrected text allowing the training model to retrain and reduce its errors with each such upload thereby become more and more accurate as time goes on. The addition of the captioning can occur as mentioned using various software, accompanying file formats understood by various media players or by including them in the appropriate MPEG-4 or other standards. It can even be multiplexed in with older technologies.

Referring to FIG. 3, the following set of steps then summarizes the approach in a series of steps. Initially, the user generates a file that includes at least an audio portion. The user uploads and submits the file that includes at least and audio portion, but may also include a video. The file is uploaded through a web site using the internet. The web site utilizes the current speech recognition model to generate the text transcript from the audio portion of the data. The text transcript is then presented to the user. User reviews the text and makes corrections to the transcript text. The corrected file is added to the original file to generate a texted file. Text file gets added back as caption layer for use by the video. Corrected text and accompanying signal is added to the training data pool allowing improvements and greater accuracy for subsequent runs of the model.

What is claimed is:

1. A computer implemented program, for generating text, wherein the program comprising the steps of:
receiving a file that includes at least an audio portion;
utilizing a speech recognition program to generate the text that is representative of the audio portion;
correcting the text; and
adding the text as a captioned layer to the file to produce a texted file, wherein the texted file includes the original file.

2. The program of claim 1, further comprising:
using a supervised machine learning technique to generate the text;
providing the automatically generated transcript text back to a user for corrections; and
updating the original text based on the user corrections.

3. The program of claim 1, wherein the text can be made available for translation to other languages.

4. The program of claim 1, wherein the text can be utilized by search engines to search through video content.
